(19) United States
(12) Patent Application Publication
(10) Pub. No.: US 2012/0284744 A1
(43) Pub. Date: Nov. 8, 2012

(54) Automated playlist generation

(75) Inventor: Kshitij Kumar, Santa Clara, CA (US)

(73) Assignee: TELLYTOPIA, INC., Santa Clara, CA (US)

(21) Appl. No.: 12/587,664

(22) Filed: Oct. 10, 2009

Related U.S. Application Data
(60) Provisional application No. 61/136,868, filed on Oct. 10, 2008.

(51) Int. Cl. H04N 21/43; H04N 21/643; G06F 3/01

(52) U.S. Cl. 725/34; 715/716; 725/110

(57) ABSTRACT

A method and system for generating playlist includes retrieving a plurality of multimedia content from a multimedia database in response to a selection received from a user and generating a multimedia playlist that identifies an order of the plurality of multimedia content. Additionally, the playlist may be updated with one or more advertisements. A video based on the multimedia playlist may be generated. The video includes the plurality of multimedia content and the at least one advertisement.

### CROSS-REFERENCE TO RELATED U.S. PATENT APPLICATION

This application claims priority under 35 U.S.C. §119(e) to U.S. Provisional Patent Application Ser. No. 61/136,868 entitled “Automated Playlist Generation,” by Kshitij Kumar, which was filed on Oct. 10, 2008, the entirety of which is hereby incorporated by reference.

### TECHNICAL FIELD

The present disclosure relates, generally, to the management and generation of a playlist of multimedia data.

### BACKGROUND

Television access is prevalent worldwide. Users of television services use such services for the availability of news, entertainment purposes, educational purposes, and the like. Additionally, the Internet and other network sources are increasingly being used for the publication and consumption of video and other multimedia content. Such multimedia includes content of interest to the general population. However, the number of users with access to the Internet and other network sources is a small subset of the users of television services. As such, a large number of television users are unable to access or cannot easily access the multimedia information available via the network sources including the Internet.

Additionally, the peer-to-peer distribution of multimedia data over networked sources such as the Internet is generally restricted to use of computer-to-computer distribution. That is, users of television services are limited in their ability to disseminate multimedia content using only the television. Additionally, the users of the television services are often restricted to viewing a predefined list of multimedia content, which may or may not be available “on demand.”

Moreover, terrestrial broadcast of Television signals is constrained to very strictly controlled selective delivery of multimedia content, and is not freely available for the general public to publish multimedia. Unlike other video destinations, broadcast and multicast of video content (on TV or terrestrially) is severely restrictive of what content may and may not be delivered.

### DESCRIPTION OF THE DRAWINGS

FIG. 1 is a snapshot of the TellyTopia System viewed end-to-end from content ingest, through content processing and management, to content delivery and play out.

FIG. 2 is a representation of TellyTopia System Hardware at the Network Operations Center (TT NOC). It constitutes both networking hardware and dedicated servers.

FIG. 3 is a legacy depiction of content flow from the TT NOC to MSO head-ends being served by a dedicated TT ICATCHER.

FIG. 4 is the current depiction of content flow from the TT NOC to MSO head-ends being served by a dedicated TT ICATCHER.

FIG. 5 is an explanation of ingest and storage mechanism of core content in the TellyTopia Content System. The source package consists of the video file, a metadata source XML, a poster, a thumbnail and a preview of the video file.

FIG. 6 is a visual folder presentation of ingest and storage mechanism seen in FIG. 4. It depicts a source content package for source obtained from a TT Content Partner.

FIG. 7 shows the contents of a VSCP package after approval process on the CCIM. Note that this does not include a .FLV preview file

FIG. 8 is a layout of TT objects as seen on the TTS screen. It can be regarded as a layout template with TT presentation objects of fixed dimensions as watched on any presentation medium.

FIG. 9 is the initial splash window showing the loading of the Playlist Designer.

FIG. 10 is a tabular description of templates for positioning of tiles on the TV screen.

FIG. 11 is the login window of Playlist Designer showing required access fields

FIG. 12 is the Playlist Settings tab in the Playlist Designer, showing different parameter settings

FIG. 13 is the displayed Create Playlist tab in the Playlist Designer, showing search and playlist creation/customization functionality

FIG. 14 is the preview playlist tab in the Playlist Designer, used for checks prior to submission for playlist creation.

FIG. 15 is the display of the review tab in Playlist Designer, showing showreels ready for delivery

FIG. 16 is the review tab in Playlist Designer, showing release details for a showreel

FIG. 17 shows the View Report Tab in Playlist Designer, containing instances of clip usage in playlists

FIG. 18 shows the Manage Asset tab in Playlist Designer

FIG. 19 is a detailed Playlist package dependency diagram

### DETAILED DESCRIPTION

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

References in the specification to “one embodiment”, “an embodiment”, “an example embodiment”, an “example”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Some embodiments of the disclosure, or portions thereof, may be implemented in hardware, firmware, software, or any combination thereof. Embodiments of the disclosure may also be implemented as instructions stored on a tangible, machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; and others.

This invention relates in the most important embodiment to the creation of play list of contents to be delivered from one networked device to another networked device. For example, the contents may be delivered from a users' PC to his television, from a users' PC to his friend(s) television(s), or to mobile devices, or even broadcast.

The purpose of this functionality in the TellyTopia product is to enable selection of processed content materials to be grouped and presented to the user. An example to relate to this is the material provided in the airlines closed circuit video system where they provide assorted material in an organized manner. Another example of this kind of system is the ability for a viewer to watch many different videos from one or more sources, some or all of it watched online, on TV or other devices, or recommended by others, and in all cases then deliver this in a playout video list form to any other device, such as online, on TV or mobile devices. TellyTopia play list may provide the capability of including advertisements (targeted or deterministic), messages and other material as appropriate to the viewer or subscriber.

One embodiment of this functionality is to allow users to record their own multimedia programming and upload it through a website. This programming could be videos that are recorded on generally available video recording or photographic/audio recording devices. Locally produced video content that is relevant to the local area—referred to as “hyper-local” content uploaded using this technology and then broadcast into a specific region via over-the-air terrestrial broadcast or into video-on-demand viewing in a Cable TV or IPTV system as well as switched broadcast or multicast into one or more regions of the system are embodiments of this functionality.

The play list functionality entails three parts, a UI front end, called the Playlist Designer, a back end that may be a web service based back end and a distribution mechanism, called localcast or hyper-localcast. The Playlist Designer enables the users (subscribers, content producers, content directors and others, including Television houses) to select content acquired from a variety of sources, including Internet web-sites and to create a Playlist that can be played back as a continuous playback on different media, in possible different formats, at different times as needed. The Playlist Designer has the capability to allow content producers to save the play list in a draft mode and preview them to edit by altering order, inserting ads (video, audio, graphic, image, or text as required). The play list is available for approval by the content director once the content producer deems it to be ready for publish. The playlist is released for publishing only after the content director approves it. The content director is an optional entity and playlists can be created and published without the need for a content director in certain embodiments.

The result of this Playlist Designer upon saving will be a Play list Configuration intermediate format document (in one embodiment an XML document) that will serve as an input to the back end web services which will tag on advertisements, text messages, short-messages (SMS) or multimedia messages and possibly other information (sometimes called DUKS—Do-you-knows) and other messages. The playlist has to be in a status (or state) that allows it to be published, but not necessarily in a format that is ready to be published on any one medium.

The back end web services (Play list Generator in one instance using SMIL) will take the play list intermediate format document, possibly a Config XML document and fetch other information such as advertisements by invoking necessary web services. The information to be fetched is either metadata that needs to be displayed with the content or other information that enhances the content. For instance, SMS messages from cellular phones might be the source of information to be inserted into such content. The video contents and the other information such as advertisements are stitched using this web service based technology in producing a SMIL file that can be played by the TellyTopia SMIL player. This is one instantiation, and in other instances, other technologies for putting together the pictures, video, text and info along with audio exist, SMIL being the specific example here.

The localcast or hyper-localcast distribution mechanism is a distributed software system that allows the creation of separate playlists for each location where the video is going to be delivered, even though the technology and human intervention needed to complete the creation and delivery of the content may be happening at a central or distributed location. The system allows creation of a near unlimited number of playlists for a near unlimited number of locations and allows distribution of the same over any networking medium, which is Internet Protocol based in one embodiment or cellular network based in another embodiment.

The play list may be composed of a single piece of content or a plurality of contents. The content of the play list, for example, may be audio, video, graphic, image, or text data. It may also be one or more of these kinds of content combined together as needed.

The contents of the play list created by the content producers, or content directors may be broadcasted to users' television. The contents of the play list created by a user may be delivered to the users' television or to their friends televisions or to other devices such as cellular phones, mobile devices, personal computers or other devices capable of being networked and capable of displaying the information contained.

An individual creating the play list may share the contents of the playlist with other individuals, such as his friends. In an aspect, contents of a shared playlist may be delivered to the TV sets of other individuals or other devices as described above. This permits individuals to share contents of their interests to be viewed by other individuals on their TV sets or other networked devices such as cellular, personal computers, or portable devices.

TellyTopia users may become members by registering themselves with the registration facility provided by TellyTopia or a partner. The member group as a whole is a TellyTopia community or a community of a customer or partner of TellyTopia. Community members may benefit from being suggested media that are of interest to other community members who have similar media interests, as well as media that the entire community finds interesting. This assists users in discovering new interesting media, as well as allowing the software to intelligently suggest and deliver more personalized video suggestions based on the user's media viewing history. Viewing of content continues as usual, while viewer suggestions, friend suggestions, community and even third party suggestions are visible on screen at the same time.

### PRIOR ART

Currently there are no means to send media from an Internet or other sources directly to the TV. There are means of installing new hardware at the premises to enable delivery of Internet content which may then be streamed around the home to be viewed on TV or other devices. Also, there are methods employed to suggest media to users. Typically used by content provider websites, related media is used to increase browsing sessions of their users by providing a continuous stream of video clips.

On these web sites, related media are displayed on content provider websites (e.g. YouTube.com, Google Video) inline with the currently viewing video. However, these related videos are only video content that reside on the content providers servers, and, are not consistently what the user expects them to be. Consequently users often find related videos that are not of high value, and are limited to just videos that content provider has on its server. Furthermore, due to limitations of video play length on these content providers, longer clips are broken up into smaller video files providing a fragmented user viewing experience.

Users uploading content to these video content web sites often upload media that are protected under copyright. These videos are illegally distributed, providing a problem for both the content provider and the copyright holder. Currently there is no method or business model behind a system that analyzes a video that a user is viewing and offering the legal (copyrighted) version directly from the copyright holder, or offers other related (legal) versions of the same content or other related content.

Prior art includes U.S. Provisional Application Ser. No. 60/996,711, filed on Dec. 3, 2007

### DESCRIPTION OF THE INVENTION

The follow subsections describe in a high level of the different components which makes up this invention. Ideally this invention is made up of both server side and client side software as well computer hardware configurations.

The TellyTopia (hereinafter referred to as TT) System is intended to enhance the user's experience by making it possible to provide a single piece of content or pre-arranged sequence of contents, acquired from a variety of sources, including Internet web-sites, to a consumer TV, primarily—to a TV set, connected in one instance to an IPTV/Satellite or Cable TV (CATV) plant via a standard digital Set Top Box (STB) or in another instance to a Digital Terrestrial TV channel broadcast over the air—or in other instances to an “over-the-top TV solution).

TT System delivers content without the user having to add any equipment or to do anything different from what he does to watch regular TV from his service provider.

Delivery of the content audio/video/text data is accomplished by TT System integrated acquisition, processing, storage and distribution Services.

TT System is built using service-oriented architecture (SOA).

Thus, from software point of view, it is essentially a collection of services. These services communicate with each other. The communication may involve either simple data passing or it could involve two or more services coordinating some activity, e.g. video data processing.

The technology of Web services is the preferred connection technology of service-oriented architectures.

Web services essentially use XMLRPC protocol, but some other service may use explicit XML file structures. These XML files may be periodically updated to create a robust connection.

To begin with, the TT system includes 37 Web Services and a number of other Services, including Private Services, which are used only inside the “parent” Services.

The TT System relies on six major Database Tables (located at TellyMaker and Portal) providing for massive storage of nearly all important textual data and metadata.

For example, the tellymaker_asset_tables.sql stores all details of all media content Assets currently available on TT System.

The TT Database tables may also contain STATUS data allowing the Services to deal with permanent changes of the current status of the whole system.

At any given time moment some TT System processes could be in progress, whilst some others may be already finished and yet some more could be running idle—waiting for their jobs.

Important feature of TT System Workflows is that they may be organized as a “Community of Independent Services”, i.e. there is no central manager, supervisor or scheduler.

This allows smooth uninterrupted production and delivery of large amounts of video data.

Also this provides for easy upgrade or modification of any Service—because there is no need to de-bug its interaction with other Services.

The topmost TT System Services are the following three:

1. Internet-2-TV (i2TV/i2TV) is a Service providing several hours long broadcast Sequence delivered to home TVs via standard switched digital cable Channel in one instance. This Sequence is often called “Wheel”, because it is replayed indefinitely, though it may be updated with some periodicity. Video content for the Sequence normally comes from TT storage server. It is arranged and timed by the Playlist/Schedule. Source of the content may be also configured as a RSS feed, then it is updated automatically. Subscriber has no control over the content, so this is essentially a form of classical Broadcast Channel aka “Multi-cast”. i2TV content may include localized and user-generated content, but the decisions to include some particular clips in the playout list are taken by TT System, not by the users themselves.

2. Internet-2-TV VOD (i2TV/iVOD) is a Video-On-Demand Service, allowing user to browse and bring to the home TV a large collection of video clips, stored or listed on TT System servers and organized by Genres (Categories). This Service can be offered free of charge (FOD); its commercial efficiency can also be based on the insertion of Advertisements. TT System iVOD Service operates in several modes: TT_Direct_iVOD—video clips are sent to the user directly from TTS servers, and TT_Partner_iVOD—video clips created by TT System are first uploaded to TellyTopia business partner VOD server, previewed and selected by the user visiting a partner's web portal, and then delivered to the user's TV from the partner's VOD server. TT technology can be leveraged to deliver the content to the VOD platforms via third party existing servers, or DVRs built into Set-top-box devices, as well as by inserting TT technology into existing devices in Cable/Satellite/IPTV networks.

3. Internet2TV is a TTS Service allowing user to browse and bring to home TV both Internet video content (e.g. user generated or semi-professional as well as professional video clips) and higher quality video clips from a list of TellyTopia business partners (so called “Walled Garden” content). This is similar to iVOD Service; the main difference is that the delivery is deferred by some time interval, because the Internet2TV content is not stored in advance on TT System servers. It is acquired and processed by TT System only in response to the specific user request. Once acquired, the Internet2TV video content data are cashed (not erased), so if another user will request exactly same clip again it may be delivered much faster.

A very important feature of the TT System Services is that they are, in fact, not orchestrated. They are rather similar to FedEx parcels delivery service.

Once requested, the video Asset will be delivered (sooner or later) to the given destination.

So, each individual request is first going upstream to the TT System Database. After this, at some later moment, the TT System will detect new request, then it will allocate all necessary processing resources and, finally, the processed video clip will be delivered.

Thus, three top-level TT System services are not just organized, but also assisted by TT System Orchestration Services and Workflows. These are used merely for preparation and delivery of the wanted video Assets.

The TT System uses an advertisement-based business model.

It relies on the functioning of two engines, namely—Ad Ingest and AdFinder, which in turn invokes Targeted_Ad_Fetch Service and Ad_Server Service.

These Ad Services provide for intrastitial (overlayed text) advertisements only.

Two engines work independent of each other, sharing the Ad Database:

1. AdIngest Service works independent of all others TT Services via its own specially developed web-UI. It allows ingesting (typing-in) or retrieving (from external sources, e.g. Internet) of textual adverts data. These data are tagged and pre-processed to make them compatible with the TT Ad data format, i.e. suitable for other TTS Services.

2. AdFinder Service allows finding the adverts matching particular video clips, thus enhancing both the user satisfaction and commercial efficiency of TT System. It uses quite sophisticated Targeted Advertising Algorithm correlating Ad Tags with Video Clip Tags supplied by Orchestration Service. For every clip the Orchestration Service requests from AdFinder the number of Ads, proportional to the video clip duration. Then, AdServer Service provides the optimized set of Ad text data suitable for final image compositing of a particular video clip with some known duration, e.g. six different Ad text strings for the 180 seconds long clip.

These three Ad Services provide for intrastitial (overlayed text) advertisements only.

The insertion of pre-rolls, post-rolls and traditional interstitial (in-between) 30 seconds long video adverts is fulfilled during video clips playout by the TTS play-out server or TT Partner play-out server.

TT System delivers video data to user's home TV via three types of hardware means offered by partners: Cable TV (CATV), Satellite TV (Sat-TV) and Internet Protocol TV (IPTV) as well as Digital Terrestrial or other delivery technologies to content viewing devices.

In any case the TT System output video content is often formatted as a set of Single Program Transport Streams (SPTS). Normally this set of SPTS files is stored on TTS servers and transferred to the partners' servers, using FTP or RSS technologies.

In case of CATV the destination is typically a Head-End video server (serving from five to twenty five thousands subscribers), but it also can be a Super-Head-End server communicating with a number of Head-Ends or it could be an equivalent in the Internet or on broadcast TV.

The TT System functionality can be upgraded to stand-alone Broadcast System level, where SPTS data are delivered directly to the final destination—users/subscribers TV screens, thus avoiding nearly all intermediate stages, e.g. communicating directly with a channel multiplexer.

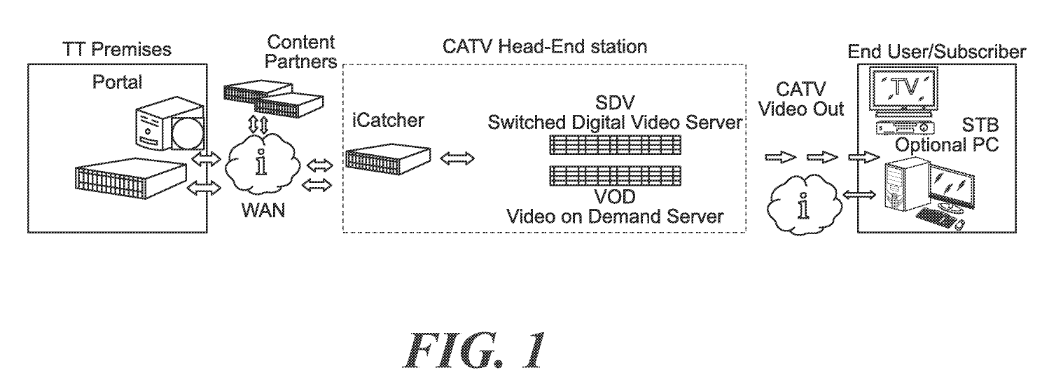

Referring to FIG. 1, The Physical Layer of the workflows is implemented using several hardware units connected via interfaces such as standard 10/100/1000 Ethernet ports and cables.

TT System consists of three major hardware units (alongside with several auxiliary units):

1. TellyMaker normally resides at TellyTopia Center premises (NOC—Network Operation Center). All major video acquisition, processing and storage Services are running on or via TellyMaker. Because TellyMaker works within the networked environment, it is possible to scale-up the capacity of TTS by inclusion of multiple TellyMakers sharing the payload. Important functions of TellyMaker are video transcoding, including image size scaling, and data preparation for image compositing.

2. iCatcher resides at the Head-End premises and serves as an interface between TellyMaker and partner's VOD and/or broadcast channel playout servers. Important functions of iCatcher are image compositing and localized targeted Ads text insertion. Typically, one iCatcher serves one Head-End location, so the number of iCatchers in the TT System should be equal to the number of destination servers. Occasionally, iCatcher may be used directly as a playout server, thus avoiding the need for any additional equipment, e.g. communicating directly with a channel multiplexer.

3. TT Portal is a classical Internet portal server showing a selection of textual and graphic content on several web-pages. The only specific things on the TT Portal are TT System software modules allowing the registered user to order delivery of video clips to the user's TV via Internet2TV or iVOD Services.

System hardware configuration consists of three major units listed above plus Core Content Ingest and Monitoring (CCIM) unit, Audio/Video Processor (AVP) unit, Network Area Storage (NAS) unit, as well as a Play-out Box and several auxiliary units.

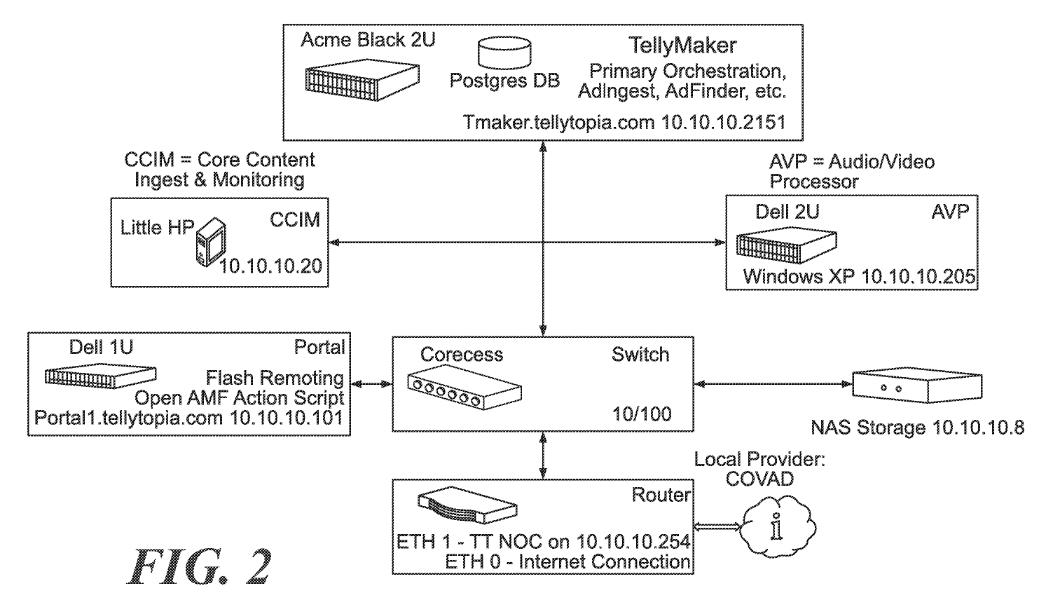

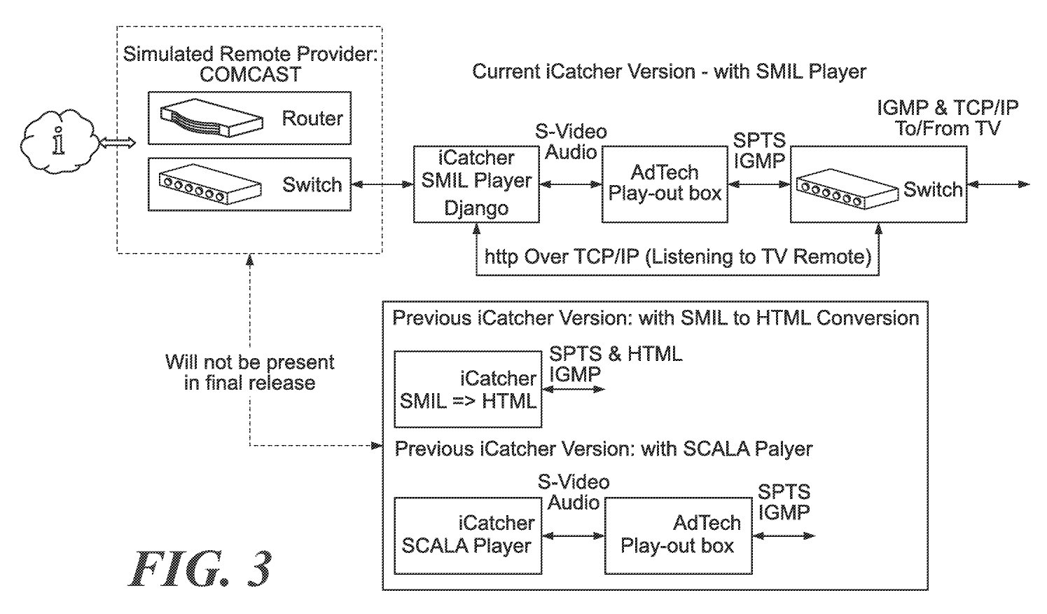

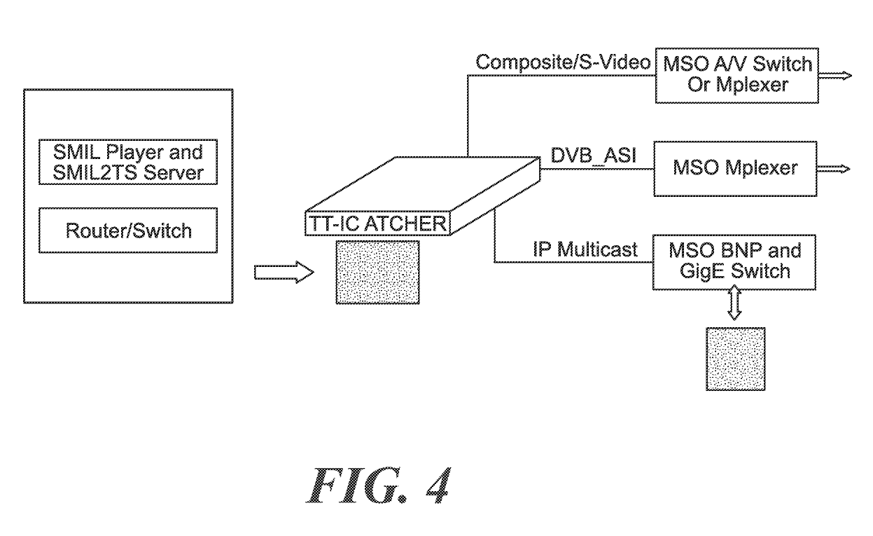

Referring to FIG. 2 and FIG. 3 as well as FIG. 4, The complete configuration of TellyTopia System hardware units is shown on those two diagrams.

In very simplified representation the flow of video content processing looks as follows:

1. Video content is acquired via Portal, FTP transfer or some other means.

2. Acquired content is then processed by TellyMaker (assisted by CCIM and AVP) and routed to iCatcher via Internet connections, using auxiliary switches and routers.

The TT System uses several standard off-the-shelf IT units, e.g. switches and routers are providing for local network connectivity and simulating remote networks functionality.

The main purpose of NAS unit (standard off-the-shelf 2 TB storage device) is to provide for centralized high capacity video content storage; it also works as a backup server.

TTS video acquisition, processing, and distribution workflows are based on the concept of Video Source Content Package (VSCP). VSCPs are created automatically or semi-automatically depending on the System Service in use. Typically VSCP consists of Video, Audio, Graphics and Textual Metadata—all related to the same Content Asset. Core Content Acquisition Workflow results in the addition of one more Asset to the collection of VSCPs listed in the TTS Database. In this embodiment, there are three sub-variants of this flow:

1 Manual load of the source content package, e.g. supplied by Content

Provider Partner

2 Subscriber (user-originated) content upload to TT Portal

3 YouTube content retrieval—initiated by the Internet user click on Firefox plug-in icon

Static pictures, forming part of TV screen presentation (Backgrounds, Logos, etc.) and not related to the particular Asset, are created off-line; they are stored as “read-only” files in the TTS Database independent of VSCPs. These generic files are used, but not modified, by TellyMaker and iCatcher.

As a result of AdIngest Workflow TellyMaker Database is regularly appended with updated ASCII text strings of Ads and Do-You-Know (DUK) data. This workflow is not scheduled or orchestrated; it runs off-line, independently of all other TTS workflows.

In the TellyMaker/iCatcher Video Processing Workflow, a SMIL (Synchronous Multimedia Integration Language) format may be used to create a script file. Each individual (customized) SMIL script controls the layout and timeline presentation of Video, Audio, Graphics, Ads, DUKs, and other pieces of information within the final Composite Image appearing on the subscriber TV.

On the request of the Orchestration Service TellyMaker takes VSCP, together with matching Ads texts and optional DUK texts data found by AdFinder Service, and converts them into a package of linked files: *.JPG static graphics, *.MPG SPTS video and *.SMIL script. Final SMIL file contains link(s) to static picture(s), all textual data of composited image, and link to the active video within this image.

The structure of the delivery package complies with CableLabs “de-facto” standard for Asset Distribution Interface (ADI). The complete ADI package of graphics/video/text files (*.JPGs+*.MPG+*.SMIL) provides for final delivery to the subscriber TV screen. Group of compositing/rendering/encoding/formatting functions forms the TTS Distribution Workflow.

Video clip and corresponding metadata XML file are mandatory components of distribution package. Other components of ADI package are optional. For example, TTS iVOD package may include optional 320×240 (4:3 aspect ratio) *.JPG Poster.

The delivery mechanism uses CORBA (Common Objects Request Broker Architecture), which is the standard interface to communicate with the Partner's VOD server whilst transferring ADI packages. Partner's VOD server should have FTP or RSS “read” access to the TT System files.

The SMIL player of the iCatcher creates the final composited image to be shown to particular subscriber or group of subscribers. For switched digital delivery channels this image must be formatted as MPEG2 SPTS.

The MPEG2 SPTS formatting in the current version of TT System is done by a server which converts the audio and video signals into SPTS as follows:

1. The 720×480 composite image and sound are rendered to the video RAM of iCatcher computer by specially developed piece of software—SMIL Player.

2. This image, together with the accompanying sound, is outputted to the server box via S-video “NTSC TV Out” and “Audio Out” connectors of the PCIe plug-in video card.

3. Analog video and audio signals are digitized by the Ad Tech box, using its built-in composite decoder and audio ADC, and then compressed into MPEG SPTS.

4. MPEG2 SPTS is outputted via a server device as a “multicast” stream.

For every fully processed iVOD package and for some Internet2TV packages the TellyMaker creates and TTS Portal receives a Portal Package. This Workflow is related, but not dependant of the processing and delivery of high quality (broadcast TV) video data. Portal Package consists of “browsing quality” 416×280 (wide aspect ratio) *.FLV video file also called Portal Video Preview, and 75×66 *.JPG Thumbnail. A collection of Portal Packages is presented on the TTS website as a band of clickable thumbnail pictures linked to playable video clips.

Unlike other TT system top level services, the i2TV service delivers a pre-arranged sequence of video clips. These clips are not chosen by the subscriber via the TT Portal, so for this service there is no mandatory request to create Preview Clips, Posters or Thumbnails. Nevertheless, it makes sense to create these files “just in case”, because some clips within the sequence could be used by other TT Services, in particular—by iVOD service.

3. TT System Workflows

3.1. Main TT System Workflows

These are:

3.1.1. Video Clip Acquisition Flow

Typically, it starts with VSCP Package Sweep—the Orchestration Service that loads many of the VSCP packages from a Portal into the TellyMaker database. Also may include such Processes as User Video Upload, Partner Video Upload, Internet2TV Request and YouTube Clip Grab.

With the exception of YouTube Access Service, includes CCIM Process.

3.1.2. Video Composition Flow

This is a TellyMaker Orchestration Service. It starts with the given Video Asset ID, includes identifying targeted Ads, Twitter message grab, creation of ADI information, and ends with composition script (SMIL) creation.

3.1.3. Distribution Flow

There are three Types of this flow:

Type I—the result is fully processed SPTS of the composite image. Full-screen SPTS is sent to Partner play-out server—directly or via iCatcher.

Type II—the results are i) partly processed (scaled) MPEG video clip, sent to Partner VOD or TT iVOD play-out server via iCatcher, and ii) all other components of ADI package, including SMIL or HTML code, sent to the destination server separately. SMIL code allows compositing and formatting of the final SPTS by iCatcher itself, whilst HTML (DHTML) code is needed to enable STB remote control interactivity functions.

In case of DHTML delivery, separate image components are converted into one composite image by the subscriber STB, e.g. Amino STB.

Type III—the result(s) is/are ETV/OCAP Application(s) sent to Partner play-out server via iCatcher in relation to other components of ADI package (including HTML) code.

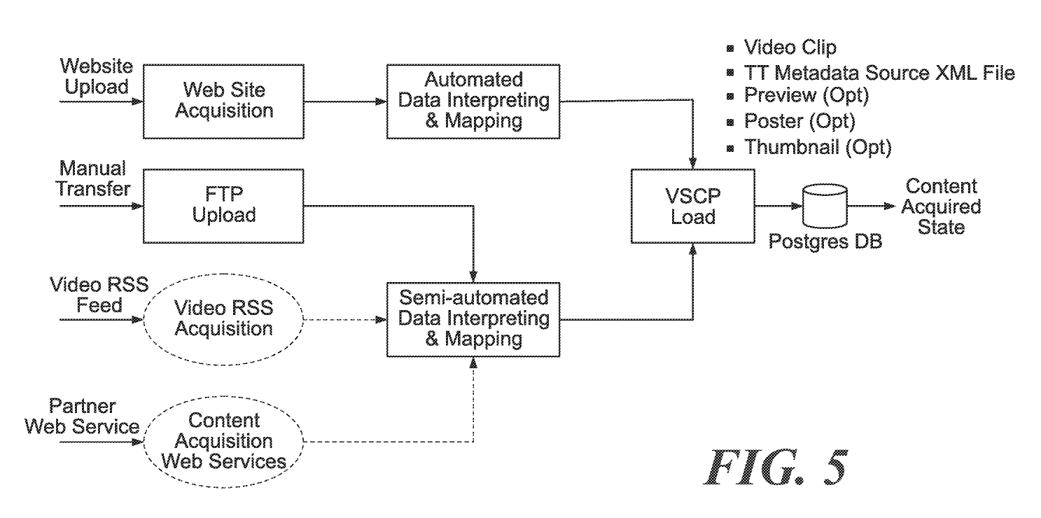

Referring to FIG. 5., Acquisition Flow, data come from multiple sources in a variety of ways but eventually end up as TellyTopia Video Source Content Packages. A video uploading online service may be used by TellyTopia's partners and subscribers to manually input metadata and information about the clip.

Important fact is that asset group ID differs from the IDs of the enclosed multi-media assets. Each asset has its own unique ID.

The VSCPs are scanned by the Package Sweep service and ingested into the TellyTopia database. Content at this state are flagged with a status ACQUIRED.

Automated flow is used for YouTube content retrieval. In this case, VSCP contains minimum number of components and the presentation layout template is fixed.

Semi-automated processing flow means that human operator runs CCIM executable GUI within standard Windows environment. Presentation layout template is selected by the Operator.

Only clips that are in the ACQUIRED state are taken up for analysis and presentation template selection.

First of all the clip is processed by CCIM built-in technical data analyzer application.

Once the automatic services are run and the clip is set to a status analyzed, the results are presented to a CCIM station GUI (except the special case of YouTube content retrieval).

In semi-automated processing flow (if CCIM is in use) the video clip is visually checked for its quality. At this time a Template (into which the video will go into) is decided and consequently the size to which the video is to be scaled.

The template selection decision is auto-hinted judging on technical parameters, but the final decision should be approved by human operator. Black bands detection and optional crop control settings are also the responsibility of the CCIM operator.

This also involves the correct estimation of picture Aspect Ratio. For example, a wide-screen (anamorphic) source video clip of size 320×240 could be enlarged to 420×216.

The VSCP consists of the video clip, the source content XML, poster, thumbnail and preview. For iVOD service Clip, Poster, and Thumbnail are mandatory whereas Preview is optional.

Optional preview .FLV file is always created automatically whereas Posters and Thumbnails .JPG files are created semi-automatically (except YouTube) because only human operator can check or select the appropriate static image.

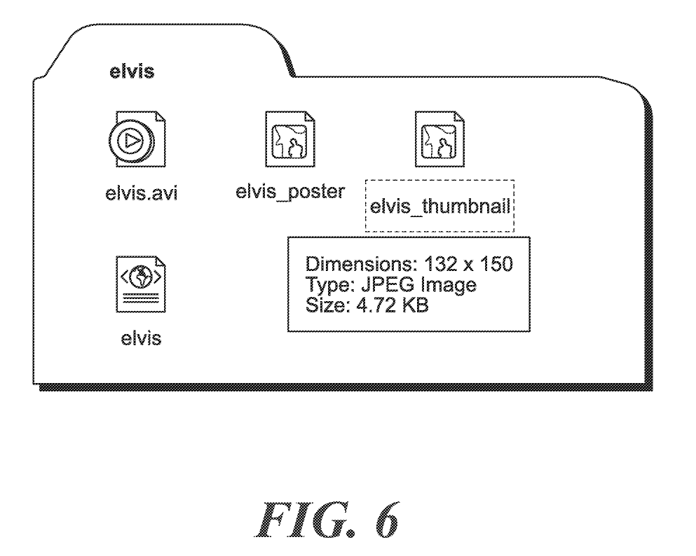

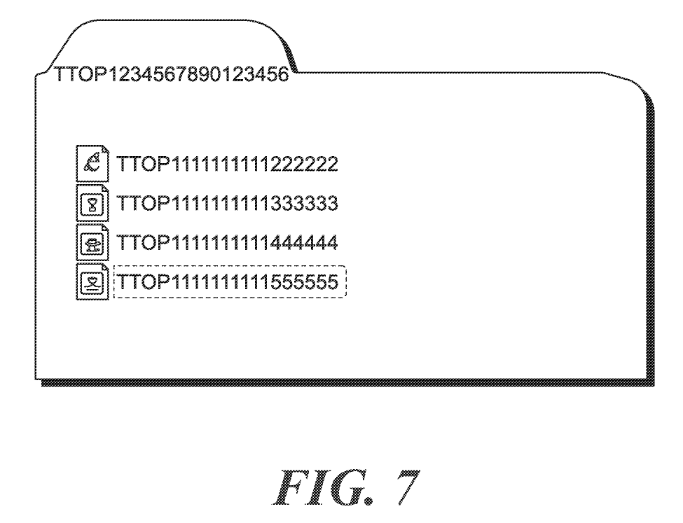

Referring to FIG. 6., Automated flow is used for YouTube content retrieval. In this case, VSCP contains minimum number of components and the presentation layout template is fixed.

Semi-automated processing flow means that human operator runs CCIM executable GUI within standard Windows environment. Presentation layout template is selected by the Operator.

Only clips that are in the ACQUIRED state are taken up for analysis and presentation template selection.

First of all the clip is processed by CCIM built-in technical data analyzer application.

Once the automatic services are run and the clip is set to a status analyzed, the results are presented to a CCIM station GUI (except the special case of YouTube content retrieval).

In semi-automated processing flow (if CCIM is in use) the video clip is visually checked for its quality. At this time a Template (into which the video will go into) is decided and consequently the size to which the video is to be scaled.

The template selection decision is auto-hinted judging on technical parameters, but the final decision should be approved by human operator. Black bands detection and optional crop control settings are also the responsibility of the CCIM operator.

This also involves the correct estimation of picture Aspect Ratio. For example, a wide-screen (anamorphic) source video clip of size 320×240 could be enlarged to 420×216.

The VSCP consists of the video clip, the source content XML, poster, thumbnail and preview. For iVOD service Clip, Poster, and Thumbnail are mandatory whereas Preview is optional.

Optional preview .FLV file is always created automatically whereas Posters and Thumbnails .JPG files are created semi-automatically (except YouTube) because only human operator can check or select the appropriate static image. The CCIM operator may be presented with thumbnail and/or poster candidate images supplied by partner. The operator approves these images or replaces them by grabbing better pictures from the video clip.

Important function of the Acquisition flow is the allocation of unique (pseudo-random) IDs.

Each TTS VSCP package may comprise unique IDs called asset_group_id. They are generated by pseudo-random algorithm, known as UUID.

Each 20 characters long ID is formed by concatenation of the reserved word “ttop” and 16 digits long sequence of random decimal numbers, e.g. ttop1234567890123456. There are also lower level pseudo-random IDs, which are applied to the individual Asset (content file) of the package or instruction files used by many Services. For example the MPEG video clip ID looks like that:

ttop5612345678901234.mpg

Original video clip name, e.g. Elvis.AVI, is effectively replaced by this new allocated unique TT System ID. However, the original file name (Elvis.AVI) still can be found in the descriptive metadata XML and corresponding TTS Database Table record. Important fact is that asset group ID differs from the IDs of the enclosed multi-media assets.

Referring to FIG. 7., Poster .JPG images acquired are resized by CCIM to fit the TTS standard 320×240 format (for both 16:9 and 4:3 sources).

The TT System standard 75×66 .JPG thumbnails (for both 16:9 and 4:3 sources) normally are produced automatically by downsizing the poster images supplied or selected.

At the CCIM Ingest station, the operator also looks for audio quality and more importantly any unacceptable audio/video content such as profanity, hate message, etc. If adult content is allowed, the operator will ensure that the genre is suitably selected.

At the end of the monitoring process, the operator will either approve or reject the Asset for further processing. When a clip is rejected Operator should supply textual metadata explaining the reason for refusal.

Typically, the operator should spend between 30 and 60 seconds examining the video clip and all the metadata presented.

There are five different Layout Templates numbered 0 to 4. Template # 0 is reserved for Full Screen Mode. In this mode input video is mapped to full size 720×480.

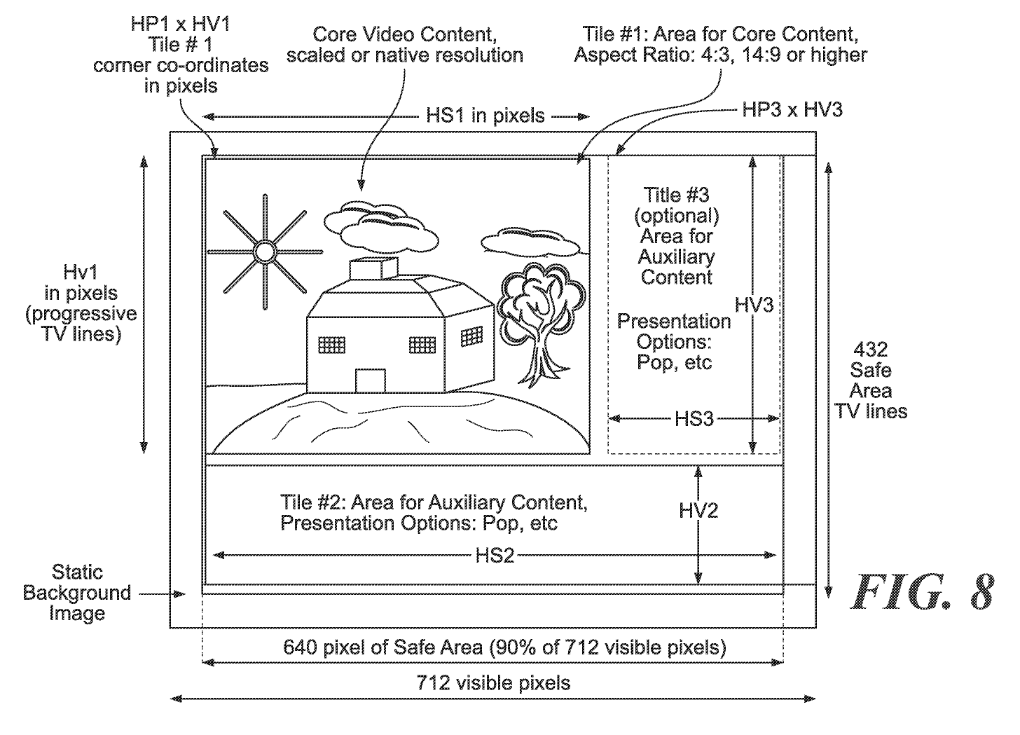

Referring to FIG. 8., Tile # 1 is reserved for Core Content Video; its size does not include any decorative elements, e.g. frame around it. All decorative elements belong to the Background Picture.

The main video content tile is positioned to the top and left of the “Safe Area” of the TV screen to provide room for the texts at the bottom and texts/pictures on the right side of the frame.

It is superimposed on static background picture, typically—a simple color pattern that includes TellyTopia logo. Because of the limited palette size of many modern STBs even uniform diagonal two-color gradients are not desirable as part of the Background Picture.

Tile # 2 is reserved for Ad texts and DUK texts whereas Tile # 3 is typically used for graphics and occasionally for very short DUK texts.

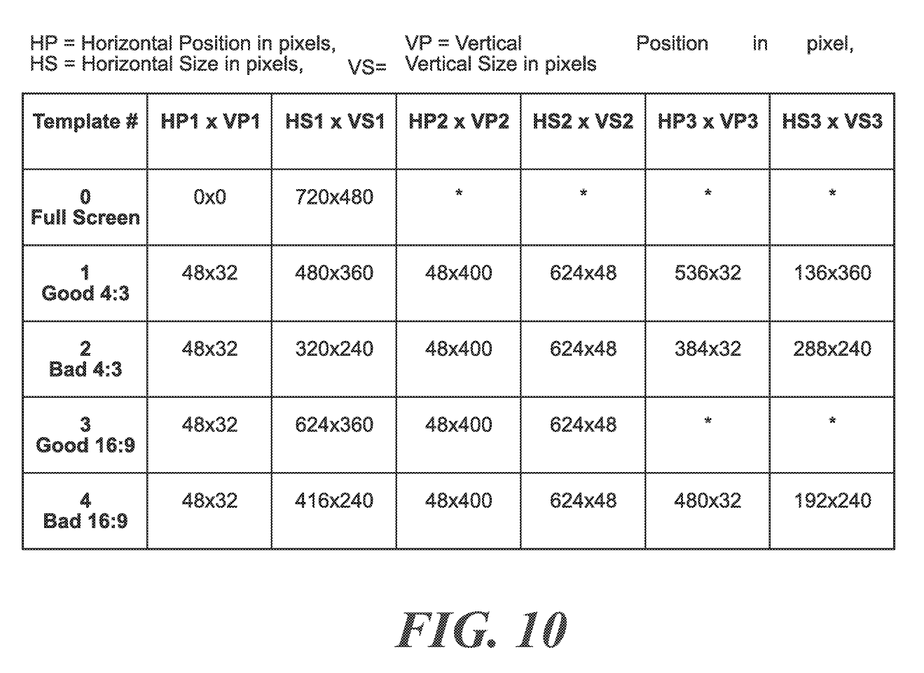

Referring to FIG. 10, There is a specially developed VSCP XML Schema, which elaborates for the three types of metadata entries for the content acquisition:

1. End User Input Data (Minimal)—This input is for subscribers and consumers who are end users of the system. The CCIM unit is not used.

2. Content Partner Input Data (Extended)—This input is for those who are partnering with TellyTopia in providing content. They usually have more information about asset metadata that needs to be captured. The CCIM unit is responsible for remapping these metadata into TTS format.

3. Complete Input Data (Detailed)—This is the superset of all metadata that is expected for an asset to be archived and retrieved. This information is more than likely to be available with the content producers and providers.

Video Composition Flow

Video Composition Flow can be considered to consist of the retrieval of VSCP data and the processing performed by the Video Processing Orchestration Service.

Beside VSCP packages Acquisition Flow creates a Database Table records, which can be used at any moment later for the formation of Audio/Video Process Control (AVPC) XML file.

The AVPC XML file indicates the required operations that the chosen video clip needs to be taken through the whole Video Processing Flow. In other words it is essential to control the operation of Audio/Video Processing System. Such decisions are made by the AVPC XML Create Service.

When the AVP sends a message conveying that the file has been processed successfully, the VPOS sets the status to processed.

At this point the video is ready to be embedded into the final presentation, along with advertisements and DUK information. The final result of the whole process is a composition file—a SMIL script.

Audio/Video Processor

AVP is the very important component of the entire TT system. It is implemented as RunAVP web service and controlled by the AVPC XML file.

AVP does not provide the final composited image, which includes background picture and Ad texts.

It creates the interim audio/video data file scaled and formatted to be suitable for final compositing in the SMIL player.

The AVP outputs MPEG-2 or in some cases MPEG-4 video, which is then decoded by SMIL player, and finally re-encoded into broadcast quality MPEG-2 SPTS by the encoder as described above.

Note that the audio component of the final SPTS needs to be AC3 for cable distribution and MP3 for IPTV and satellite distribution.

Also AVP creates optional .FLV Preview Video scaled to fit TTS standard Preview Image Size: 416×240 (Aspect Ratio =always 16:9, dimensions divisible by 16).

3.1.3 Distribution Flow

Type I

The Type I distribution flow is used now mainly for the i2TV service, but it can be used for iVOD and Internet2TV as well.

In case of i2TV distribution the additional Playout Script is needed. The Playout script created manually at the TellyMaker, then transmitted and archived at a preset location on the iCatcher.

Type II

The Type II distribution flow is used now mainly for the iVOD and Internet2TV services.

Type III

The Type III distribution flow is reserved for other distribution flows such as for satellite, cable, and IPTV network distribution using standards such as OCAP, ETV, and MHP.

SMIL Script Issues

A small change is made to classic SMIL schema. An attribute value is introduced (the type identifier) in the assets tag such as text. This is needed because depending on the duration of the clip, there can be any number of corresponding Ads and/or DUKs.

Using the SMIL Designer software a SMIL Template file is created off-line for each of the templates. This is referred to as the SMIL Script Repository.

Based on the template selected for a clip, the corresponding SMIL script is chosen from the repository and it is modified according to the duration of the clip, and the targeted Ads and DUKs for the same. The resulting custom SMIL script file is transmitted to the same iCatcher folder as the ADI package.

All SMIL scripts indicate each Ads or DUK location (full path) in the TellyMaker database with an URL, e.g.

http://www.tellymaker.com/addatabase/TTOP1234567890123456.txt

The Set top Box HTML Creator Service takes the SMIL script file for the clip and outputs a custom HTML file. This automatic translation application takes into account the specific features of HTML browser the file is destined for (e.g. Amino STB or CableVision HTML or something else). Thus local HTML creator operates on local iCatcher and creates a custom HTML (with JavaScript fragments) suitable for the required STB.

SMIL Playlist Generator issues

The purpose of this web-based program under development is to select a bunch of content available within the TellyTopia content database and create an i2TV Service Playlist(s) in form of SMIL file(s).

The User Interface for this program should allow the operator to:

1 Filter and sort-out available ADI packages by one or more of the following:
Time interval
Genre
Keywords
Part of Title
Provider
Clip duration
Quality
Template

2 Set the Business name and TTS ID. Once this is set, the available iCatchers with this television service provider is listed. The operator will select one or more of them.

3 Put the operator's name when creating the Playlist to track who created the Playlist.

4 Set the duration of the Playlist (with default to 15 minutes)

5 Preview any chosen clip and select clips to arrange the order of their presentation, rearrange clips or delete a clip from the Playlist

6 Select a preamble (pre-roll) video

7 Open any file of any type available at TT System (in “read-only” mode)

8 Select a filler (padding) video fragments to provide for the Playlist exact duration (e.g. 15 minutes). The filler video may be interrupted at any moment to let the new 15-minutes Playlist segment to begin

9 “Publish”, i.e. enable creation of the Playlist SMIL file

10 Save and reopen the Playlist file to continue work at a later time with several options:

Different states for the Playlist file—Draft, Awaiting Approval, Rejected, Published

TT System Services

i2TV Service

This system level service workflow starts with manual preparation of the sequence Playlist (ordered group of video clips from the available repository of TTS Assets) and finish with SMIL player running non-stop Wheel (loop) of this Playlist on local iCatcher.

The i2TV service workflow includes automatic search for new/updated set of localized targeted text Ads, matching the Genre and other features of each video clip of the sequence. The localization means that the Ads selected may vary depending on the Partner's Head-End location.

iVOD Service

This system level service workflow relies on preliminary semi-automatic preparation of the several groups of video clips pre-scaled to match the selected templates and sorted by Genres (Categories).

The workflow includes automatic search for new/updated set of localized targeted text Ads, matching the Genre and other features of the particular video clip selected by the particular subscriber via the TTS Portal and/or on-screen Interactive Menu of the STB.

The iVOD service workflow finish with automatic run of SMIL player on the iCatcher connected to the subscriber MSO Head-End servers. Each time the SMIL player generates new/updated version of the composite images of one video clip.

Internet2TV Service

The main differences between Internet2TV and iVOD services are: i) the process of video clip selection and ii) fully automated processing with fixed presentation template.

In one case, this system level service workflow starts with the user/subscriber browsing some top video website and selecting a clip to be delivered to the user's TV screen. The most obvious example is clip from YouTube.com. To process video clips from the YouTube website TT System should fetch not only the clip itself, but also all related metadata. This is the job of specially developed FireFox plugin “Internet2TVr.xpi”.

Another mode of operation of Internet2TV service is the delivery of the uploaded user-generated video to the subscriber home TV or any other TV set listed in the user profile. In this case the Asset metadata must be supplied by the user via the web-form dialog of the TTS Portal UI.

Once collected, the Internet clip data and metadata are processed by TT System like any other acquired clip—as described above.

TT System Portal

Important part of the TT System is its Internet Portal. It is powered by ubiquitous Apache/Tomcat engine and its code is written primarily in Python, HTML and Java Script.

This portal is used for two rather different purposes united under the brand name TellyTope:

1. Portal supports the TT System iVOD service. There is a tab “My Videos” allowing the registered subscriber to browse thumbnails (with short textual descriptions) and preview available video clips, then select the clip(s) to be delivered to the subscriber's TV—as configured in the subscriber profile.

2. Portal also provides tools to upload user-generated video clips with appropriate metadata. This process starts when user selects the tab “Upload Video”. Once uploaded, the video clip will be processed by the TTS system like any other Asset. There are some legal issues concerning the final destination and usage of this type of Assets. The most obvious issue is the copyright disclaimer. Uploaded user-generated clips are becoming property of TellyTopia; this allows TT System to legally modify the presentation of these Assets, combine them with Ads, etc.

From iVOD service point of view the TellyTope portion of the TellyTopia Portal does two main things:

1. Displays on the subscriber computer screen previews and thumbnails of TT System Assets the user can choose to “TellyTope”.

2. “TellyTopes” video clips—that is, sends information about the user and the videos the user has chosen to the rest of the TT System.

The Portal UI and the DB tables created were designed to keep track of and display (in the page “My Videos”) TellyTope Requests that the user has already made.

Process

A process is a unique process flow, through a sequence of services, for an asset, such as a video clip. As an example, a process may take a video clip from ingest through distribution to a cable service provider.

A process is represented by a unique process identifier, the Process ID.

Service

A service typically performs one operation in the process of an asset. For example, technical information analysis on a video clip is performed by a service.

Each service is represented by a Service ID.

Process Request

A Process Request is a request to perform a process on an asset, such as a video clip. One Process Request can be used to process only one clip.

Each Process Request is uniquely represented by a Process Request ID.

Service Request

A Process Request is executed typically by a series of Service Requests.

Typically, each Service Request performs a service on an asset, such as a video clip.

Process Request-Set

A Process Request-Set is a request to perform a process on a set of assets, such as a set of video clips. A Process-Request Set will result in several Process Requests.

Each Process Request-Set is uniquely represented by a Process Request-Set ID.

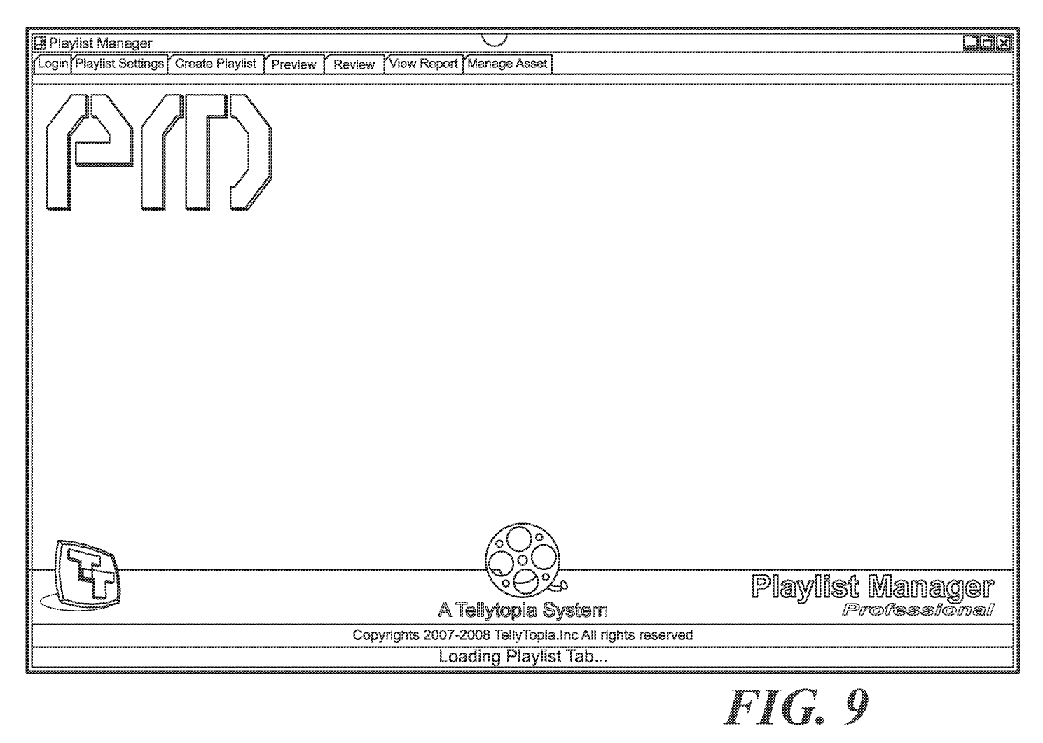

Referring to FIG. 9, SMIL Playlist Manager Description

The purpose of this functionality in the TellyTopia product is to enable selection of processed content materials to be grouped and presented to the user. A typical example to relate to this is the material provided in the airlines closed circuit video system where they provide assorted material in an organized manner. TellyTopia Play list will provide the capability of including advertisements (targeted or deterministic), messages and other material as appropriate to the viewer or subscriber.

The Play list functionality entails two parts, viz., a UI front end, called the Playlist Designer and a web service works at the back end. The Playlist Designer enables the users (subscribers, content producers and content directors) to select content within the TellyTopia content database and create a Play list. The Playlist Designer has the capability to allow content producers to save the play list in a draft mode and preview them for editing by altering order, inserting ads (text, image & video ads) as required. The Play list is available for approval by the content director once the content producer deems it to be ready for publish. The play list is released for publishing only after the content director approves it.

The result of this Playlist Designer upon saving will be a Play list Config XML document that will serve as an input to the back end web services which will tag on advertisements, DUKS and messages. The Play list has to be in a status (or state) that allows it to be published.

The back end web services (Play list SMIL Generator) will take the Play list Config XML document and fetch advertisements by invoking necessary web services and passing in required parameters. The video contents and the advertisements are stitched in this web service in producing a SMIL file that can be played by the TellyTopia SMIL player and hence final showreel (TS file) is created with all the selected Ads using Ad Finder.

Functional Overview of Playlist Manager: The objective of the Play list Designer UI is to produce an XML document called Playlist Config file that provides all the relevant information to the Play list SMIL generator, a web services, running at back end, for creating the SMIL file.

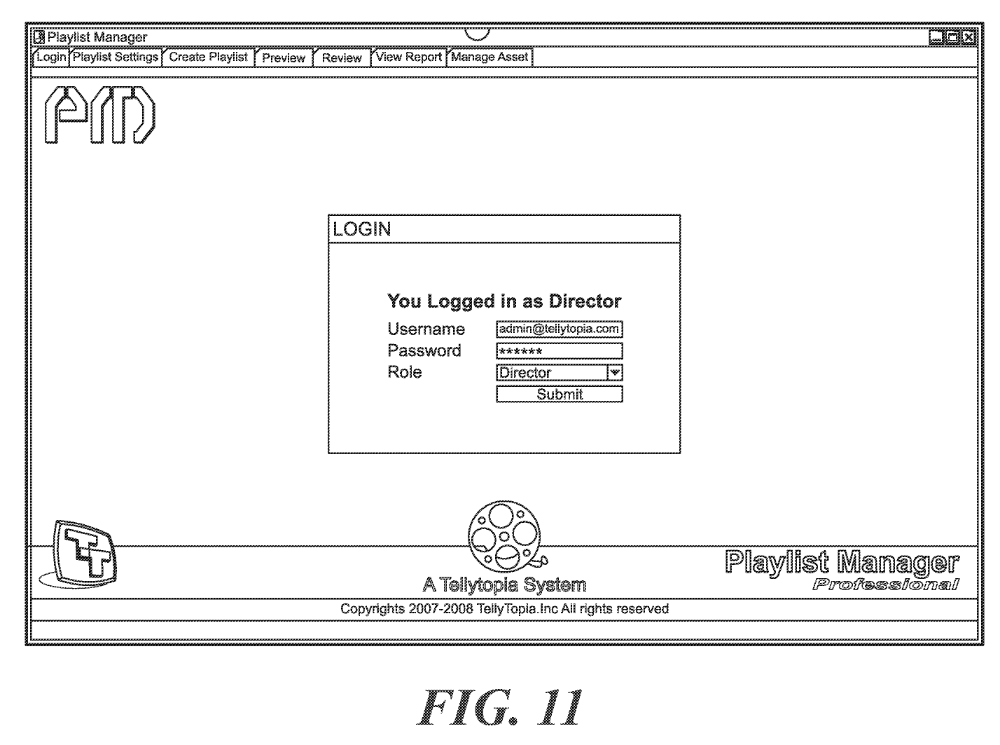

So we have divided the whole process in the following steps: Splash Screen: Once Playlist Manager executable is launched, it will start populating its tabs from the database and show you the status on the Splash Screen as shown in FIG. 11.

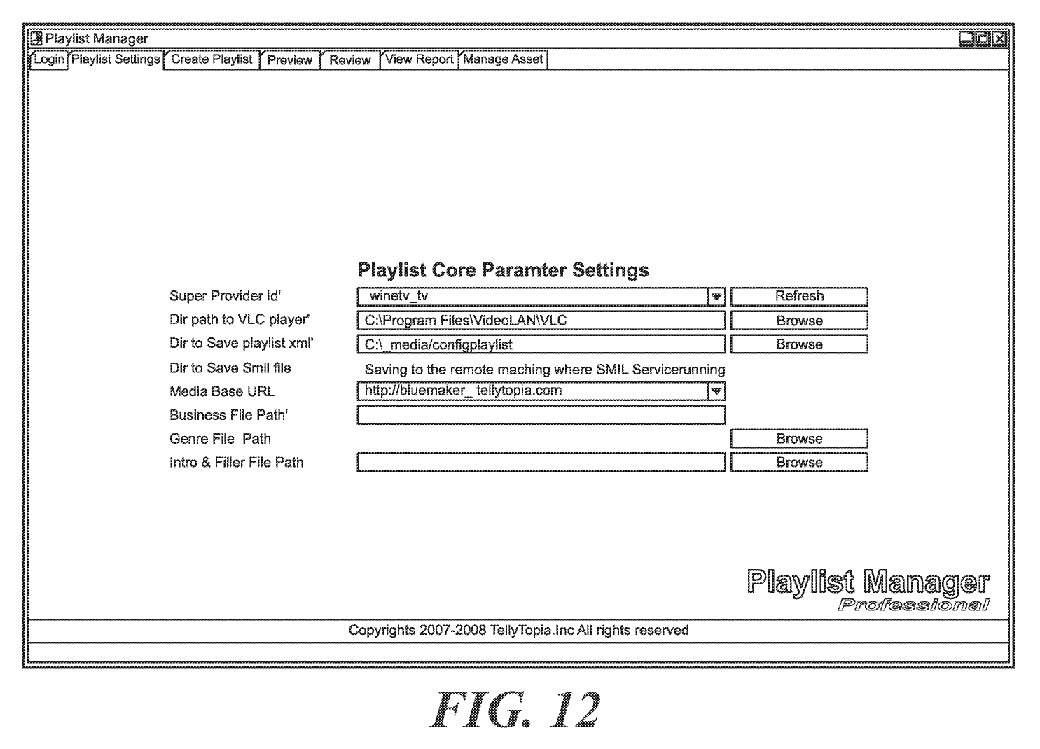

Referring to FIG. 12, Login Screen: This screen provides fields to input user credentials and authorize a user to access the rest of the application. It takes 3 inputs parameters username, password and role. It validates the user against master database. If credentials are validated, enables the rest of the tabs and shows message on UI to the user with user role, otherwise shows try again message on the login screen. Once the login is successful, it shows the logged in user role in the message at the top.

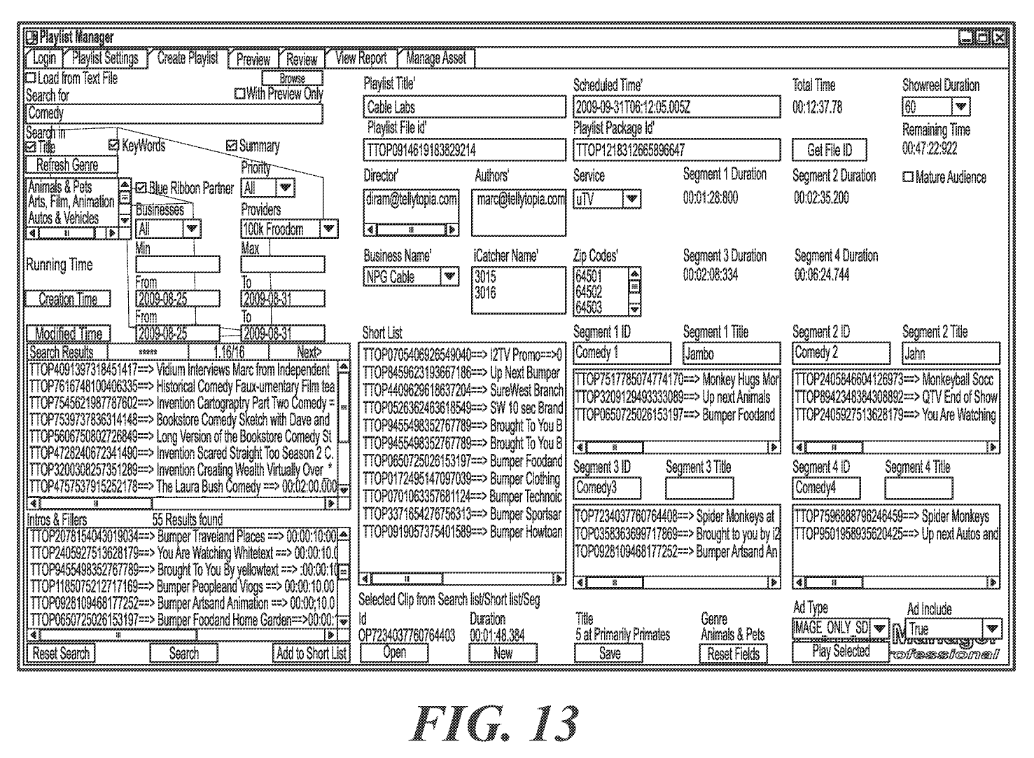

Referring to FIG. 13, Setting Screen: This screen allows user to provide some settings which supports creation of play list configuration xml file. Setting gives the flexibility to the user to change the behavior of the application.

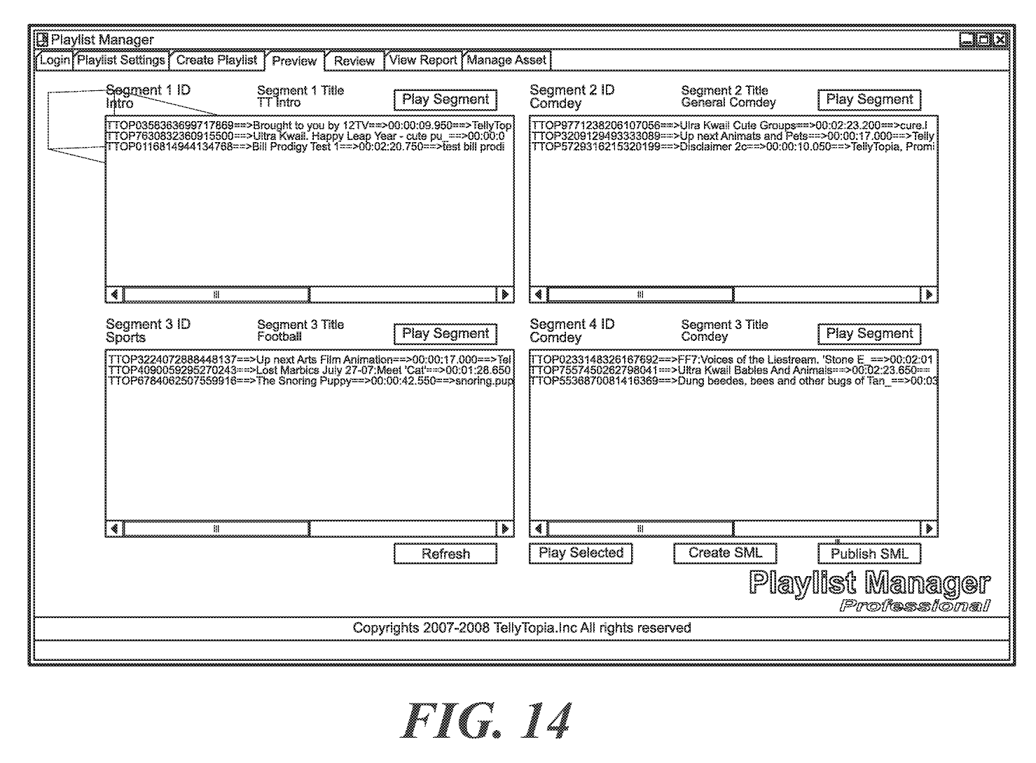

Referring to FIG. 14, Following parameters can be programmed. Super Provider: If you are not TellyTopia admin, you will see your Super provider only. If you are TellyTopia admin, you will see all the Super Provider and can switch to any Super Provider.

VLC Player Path: This is used to launch the vlc player when the user wants to play the assets using the Playlist Manager UI. So set it to the path of VLC player installation directory.

Saving path of playlist configuration file: Playlist Configuration file is getting saved to the directory specified in this field, default value is coming from TT_TellyMaker_Config. xml.

Saving path of the Smil file: Smil file is getting saved to the path specified in TT_TellyMaker_Config.xml, This file is placed on the server where SMIL generator service has been deployed.

Media Base Url: This url is used to find out the location of the Assets to be played. If it is left blank, it means media resides on the machine where Playlist Manager UI is launched i.e. client machine and he wants to play the selected asset from the local machine only.

Business File Path: This is used to populate the Business, Icatcher and zipcode fields in the “Create Playlist” tab UI. In old version (version 1.1.2) these values were coming from this text file. Now these values directly coming from master database.

Genre File Path: If the user specifies the text file path in the field, genre gets loaded from this file in the “Create Playlist” tab. If the user leaves it blank, Genre gets loaded from master DB. If the file is invalid, not in desired format, it shows pop up message.

Intros and Filler File Path: This field is used to populate the intros and fillers in “Create Playlist” tab from text file. If the user specifies the text file to be loaded, then Intros and fillers come form this text file. If the user leaves it blank, Intros and fillers gets loaded from master DB.

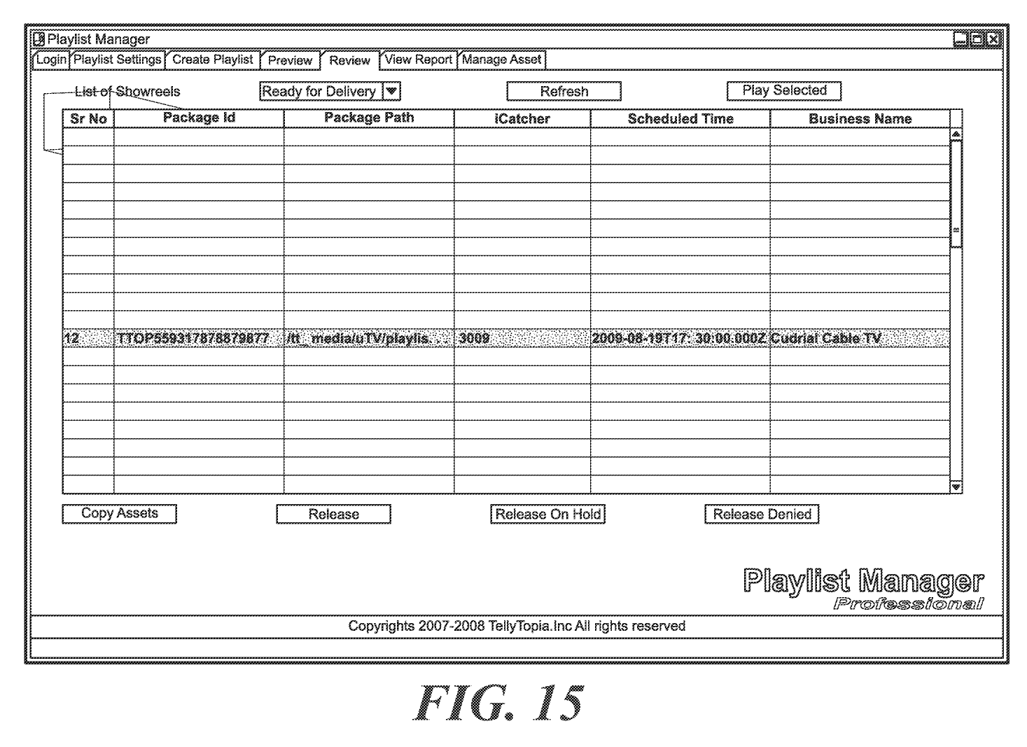

Referring to FIG. 15, Playlist Search & Create Screen: There are 2 parts in the screen left part is for searching the assets and right part is for creating the playlist config xml file. User can search on the basis of the following parameters shown below or he can load the assets from text file, if text file option is selected in the playlist UI. If the search text is inputted in the search field, search functionality searches for the assets in the DB based on the user search parameters. Play list Manager has following parameters: Search Parameters, Title, Key Words, Summary, Genre, Priority, Content Provider, Business , Min Duration or Run Time, Max, duration or Run Time, Creation time duration, Web Preview Availability, Blue Ribbon Partner.

Key Functions: Searches assets/clips from DB on selected criteria. Load assets from the chosen text file, if file option selected. Load genre from DB, if genre file not selected in the setting tab. Load genre from text file which has been selected in the setting tab. Reset search criteria for new search. Load Intros & Fillers from DB, if file not selected in the setting tab. Load Intros & Fillers from text file which has been selected in the setting tab. Dynamically loading ICatcher and Zipcodes from Business Name. Drag and Drop assets into short list or into segments for creating playlist config xml file. Auto filling of Playlist File Id and Playlist Package Id. Auto filling of Created and modified time. Showing the details of selected asset on the UI. Asset play sequence modification in segment by drag and drop up/down. Showing asset duration, Segment total duration and playlist duration and dynamic update of durations on drag and drop. Shows expected showreel time and remaining time fields and updates these fields dynamically on each drag, drop and modification in duration. Give options to user to select mature ads for mature showreels. Providing “Open” functionality for playlist configuration file so that any draft playlist can be opened and modified. Providing “New” file functionality for creating new playlist config xml file. Providing “Save” functionality to save playlist configuration xml file on the specified location in setting tab. Providing “Reset fields” for creating new playlist config xml file. Providing “Play selected” asset in VLC player in “Create Playlist” tab. Modifying the Ad Type of an asset. Modifying Ad Include status of an asset. Providing right click menu to modify the “run time” of an asset/clip

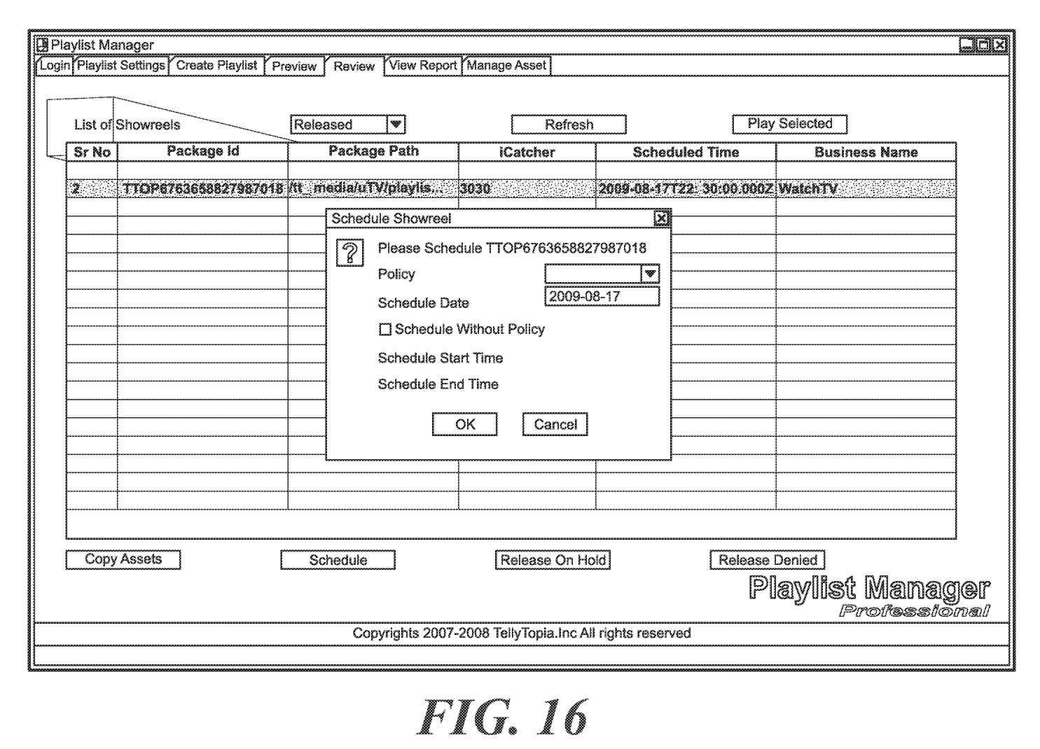

Referring to FIG. 16. Preview Screen: This tab is used to preview the playlist configuration which has been created by the user. It shows the assets used in the playlist configuration xml file and provide the option to play the either selected clip or the whole segment. It also provides option to create SMIL file and publish SMIL file. When the “Create SMIL” option is selected, it calls the web service and passed the playlist config xml file as string to the web service. “Publish SMIL” option changes the status of the file and file is ready to be converted into TS (transport stream) file. Key Functions

Providing “Refresh” option to load the data from “Create Playlist” tab. Providing “Play selected” option to play asset in VLC player. Providing “Play Segment” option to play all asset in VLC player. Providing “Create SMIL” option to create smil file on the server. For Sample smil file please see the ANNEXURE 3. Providing “Publish SMIL” option to make showreel available to broadcast.

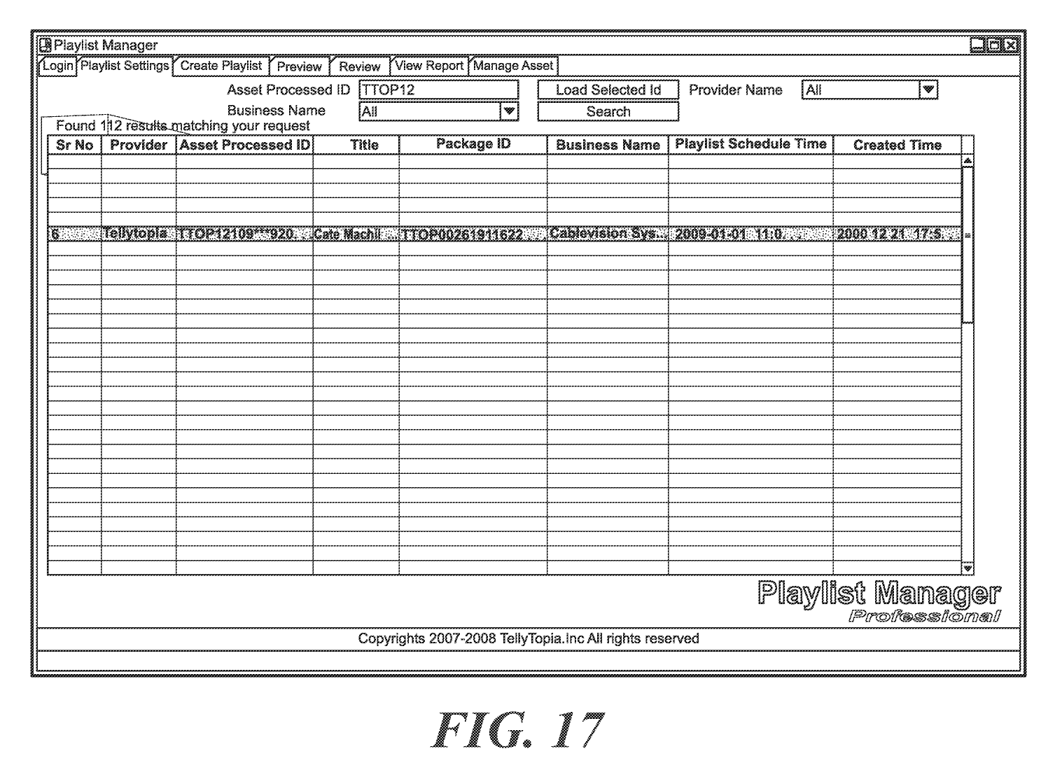

Referring to FIG. 17., Review Screen: This tab only meant for Directors or Admin actually. The director/Admin could go to this tab and play the selected transport stream. User can also change the status of the transport stream. Status means whether user wants to release showreel, hold showreel or deny the release etc. The director plays all the transport streams and decides the status of the transport streams. He can also see the actual content of the showreel by selecting the option “Copy Assets” and user can re create the same showreel again. Once the user selects this option, the assets of the selected showreel, are copied in “Create Playlist” tab.

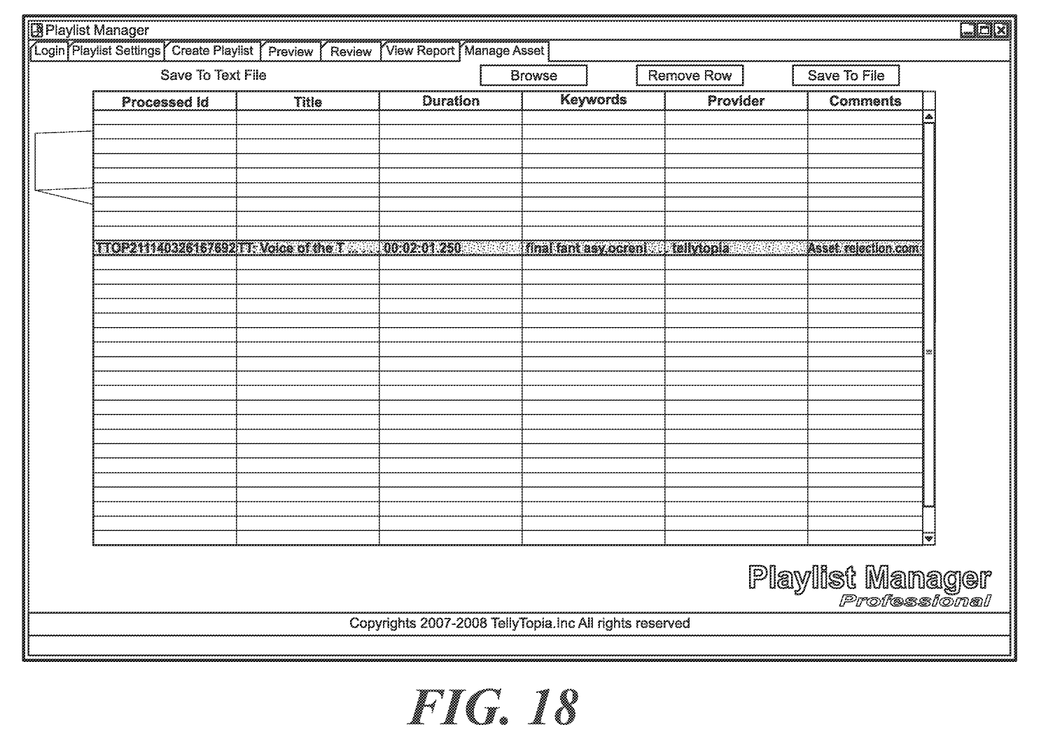

Referring to FIG. 18, Screen shows how user schedules the specific showreel for a business and user could select the Policy or direct date and time to schedule that. Key Functions

Providing “Refresh” option to load the showreels from database for selected value in combo box. Providing “Play selected” option to play showreel in VLC player. Providing “Copy Assets” option to copy the showreel assets into short list box of “Create Playlist” tab. Providing “Release” option to release the showreel if user finds it valid to broadcast to the TV. Providing “Release On Hold” option to hold the release the showreel if user finds it invalid to broadcast to the TV. Providing “Release Denied” option to deny the release the showreel if user finds it invalid to broadcast to the TV. “Release” button is toggle button, for released showreels, it changes into “Schedule” option. If you click “Schedule” button user sees the pop up to schedule the showreel for a particular business. User has flexibility to schedule for a policy or specific time.

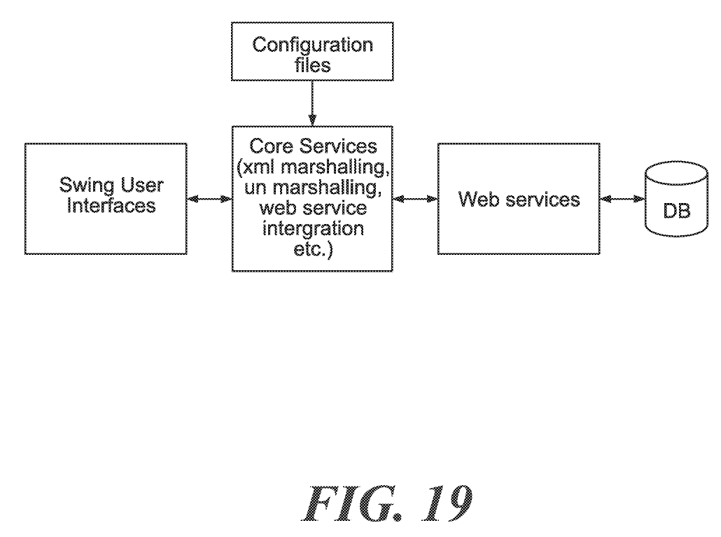

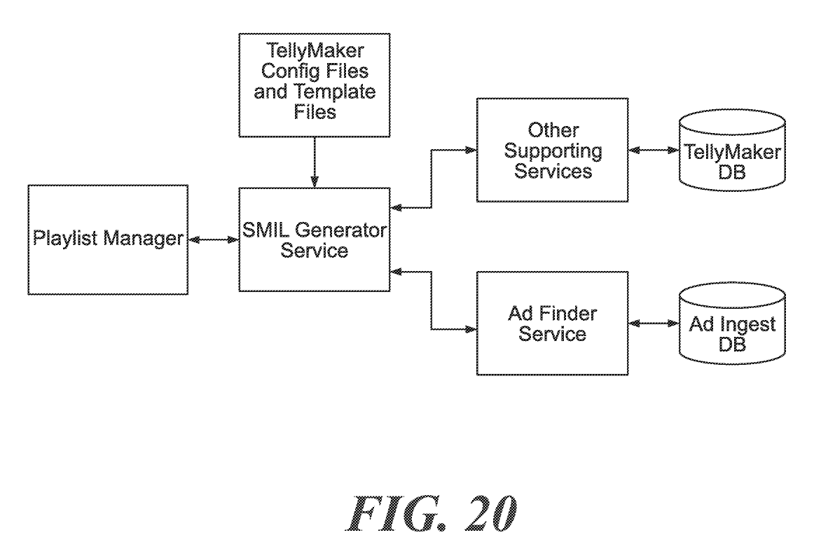

Referring to FIG. 19. Report Screen: This tab is used for finding the report of an asset/clip. It has got option for partial search and returns the history of an asset, where all an asset/clip has been played so far. There are some search parameters to identify an asset. It shows playing details of an asset where all an asset has been played and who is the provider of an asset and other relevant info.

Key Functions: Providing “Load Selected Id” option to load the processed id of an asset which has been selected in search result box of “Create Playlist” tab.

Providing “Provider” option to select provider for a search.

Providing “Business” option to select business for a search.

Providing “Search” option to search the relevant data.

Manage Asset Screen: This tab is used for creating the report of the assets which will help CCIM (Core Content Ingest Management) operator to take necessary actions based on Producer feedback on assets. Suppose if Producer does not find any asset suitable for creating the show reel then asset meta data (along with the producer's comments on asset) will be sent to this tab by right clicking the asset in “Create Playlist” tab. Producer can create a text file for the assets which need to be modified.

Key Functions: Providing “Browse” option to save the text file on local machine. Providing “Remove” option to remove the selected asset from the list. Providing “Save To File” option to save the text file with asset meta data.

Referring to FIG. 20. SMIL Service Overview

This XmlRpc service is invoked by the “Playlist Manger” to generate the smil file. See ANNEXURE 3 for sample smil file. Playlist Manager Supplies the playlist config xml file as a string to the SMIL Generator Service and SMIL service generates the SMIL xml file and save SMIL as well as playlist config file onto the server. While creating the SMIL xml file, it embeds ads and other data as well into the SMIL xml file. It mainly takes care of Ad ingest and template insertion into the SMIL file. Moreover once this SMIL file is published, this file is further processed by the orchestration services (SMIL player and other dependent services) to convert it into transport streams. SMIL Generator Service is a java based service running on Tomcat server. High Level Overview: This explain the flow of the playlist config xml file from Playlist Manager to SMIL Generator service and finally SMIL file gets created on the sever in their respective folders with Ads in the main folder and ad reference in the SMIL file.

There is a plurality of advantages of the present disclosure arising from the various features of the apparatuses, circuits, and methods described herein. It will be noted that alternative embodiments of the apparatuses, circuits, and methods of the present disclosure may not include all of the features described yet still benefit from at least some of the advantages of such features. Those of ordinary skill in the art may readily devise their own implementations of the apparatuses, circuits, and methods that incorporate one or more of the features of the present disclosure and fall within the spirit and scope of the present invention as defined by the appended claims.

1. A computing device for generating a playlist of multimedia data, the system comprising:
a processor; and
a memory device coupled to the processor and having stored therein a plurality of instructions, which when executed by the processor cause the processor to:
retrieve a plurality of multimedia content from a multimedia database in response to a selection from a user;
generate a multimedia playlist that identifies an order of the plurality of multimedia content;
determine text or multimedia information based on the plurality of multimedia content;
update the multimedia playlist with the multimedia information including the temporal order and spatial location of the multimedia information; and
generate a video based on the multimedia playlist, the video including the plurality of multimedia content and the multimedia information associated therewith.

2. The device of claim 1, wherein the multimedia playlist and the multimedia information can be delivered to and displayed on one or more video display units.

3. The device of claim 2, wherein the video can be provided to the device from an Internet website, from personal computing devices, cellular devices, potable devices and from the one or more video display units.

4. The device of claim 3, wherein the multimedia information is displayed with the video and can be changed each time the video is displayed to include information that is relevant at the a point in time when the video is displayed.

5. The device of claim 4, wherein the multimedia playlist can be created and distributed into Terrestrial Broadcast for reception over air with antennas, distributed into CableTV and IPTV networks for distribution into Television sets, can be distributed over Internet Protocol networks for distribution to devices that may have an Internet Protocol connection, as well as distribution into other networked devices.

6. The device of claim 5, wherein multimedia messages from other devices selected from cellular phones, personal computers and Internet Protocol enabled devices can be received and directed into the video and displayed at locations on a screen of the display device at a specific time during the video playlist playback.

7. The device of claim 6, wherein users can any of:
send a playlist they are watching to another user;
send any other playlist to the another user;
send another playlist to the another user;
recommend the playlist they are watching on a scale that is shared with other users and can be used to evaluate whether to watch the playlist; and
as users are watching a playlist, recommend one or more playlists based on past history and other playlists they may have searched for or watched in the past.

8. A method for collecting, distributing and displaying multimedia content on a display device, the method comprising:
retrieve a plurality of multimedia content from a multimedia database in response to a selection received from a user;
generate a multimedia playlist that identifies an order of the plurality of multimedia content;
determine text or multimedia information based on the plurality of multimedia content;
update the multimedia playlist with the multimedia information to be displayed including a temporal order and spatial location of such information; and
generate a video based on the multimedia playlist, the video including the plurality of multimedia content and the multimedia information associated therewith.

9. The method of claim 8, wherein the multimedia playlist and the multimedia information is delivered to and displayed on one or more video display units.

10. The method of claim 9, wherein the video can be provided to the display device from an Internet website, from personal computing devices, cellular devices, portable devices and from the one or more video display units.

11. The method of claim 10, wherein the multimedia information displayed with the video can be changed each time the video is displayed, to include information that is relevant at a point in time when the video is displayed.

12. The method of claim 11, wherein the multimedia playlist can be created and distributed into Terrestrial Broadcast for reception over air with antennas, distributed into CableTV and IPTV networks for distribution into Television sets, can be distributed over Internet Protocol networks for distribution to devices that may have an Internet Protocol connection, as well as distribution into other networked devices.

13. The device of claim 12, wherein multimedia messages from other devices selected from cellular phones, personal computers and Internet Protocol enabled devices can be received and directed into the video and displayed at locations on a screen of the display at a specific time during the video playlist playback.

14. The method of claim 13, wherein users can any of:
send a playlist they are watching to another user;
send any other playlist to the another user;
send another playlist to the another user;
recommend the playlist they are watching on a scale that is shared with other users and can be used to evaluate whether to watch the playlist; and
as users are watching a playlist, recommend one or more playlists based on past history and other playlists they may have searched for or watched in the past.

15. A system for collecting, distributing and displaying multimedia content on a display device, the system being configured to:
retrieve a plurality of multimedia content from a multimedia database in response to a selection from a user;
generate a multimedia playlist that identifies an order of the plurality of multimedia content;
determine zero or more text or multimedia information based on the plurality of multimedia content;
update the multimedia playlist with the multimedia information to be displayed including a temporal order and spatial location of such information; and
generate a video based on the multimedia playlist, the video including the plurality of multimedia content and the multimedia information associated therewith.

16. The system of claim 15, wherein the multimedia playlist and the multimedia information can be delivered to and displayed on the one or more video display units.

17. The system of claim 16, wherein the video can be provided to the display device from an Internet website, from personal computing devices, cellular devices, potable devices and from the one or more video display units.

18. The system of claim 17, wherein the multimedia information displayed with the video can be changed each time the video is displayed, to include information that is relevant at a point in time when the video is displayed.

19. The system of claim 18, wherein the multimedia playlist can be created and distributed into Terrestrial Broadcast for reception over air with antennas, distributed into CableTV and IPTV networks for distribution into Television sets, can be distributed over Internet Protocol networks for distribution to devices that may have an Internet Protocol connection as well as distribution into other networked devices multimedia messages from other devices such as cellular phones, personal computers and Internet Protocol enabled devices can be received and directed into the video to be displayed at locations on the screen as required, at specific time during the video playlist playback.

20. The system of claim 19, wherein users can any of:
send a playlist they are watching to another user;
send any other playlist to the another user;
send another playlist to the another user;
recommend the playlist they are watching on a scale that is shared with other users and can be used to evaluate whether to watch the playlist; and
as users are watching a playlist, recommend one or more playlists based on past history and other playlists they may have searched for or watched in the past.
